(19) United States
(12) Patent Application Publication
(10) Pub. No.: US 2026/0296330 A1
(43) Pub. Date: Oct. 1, 2026

(54) VEHICLE POWER TAILGATE HAVING SYNCHRONIZED REAR VIEW CAMERA

(71) Applicant: Ford Global Technologies, LLC, Dearborn, MI (US)

(72) Inventor: Adrian Nania, Rochester, MI (US)

(73) Assignee: Ford Global Technologies, LLC, Dearborn, MI (US)

(21) Appl. No.: 19/095,134

(22) Filed: Mar. 31, 2025

(51) Int. Cl. B60R 11/04; E05F 15/611

(52) U.S. Cl. CPC B60R 11/04; E05F 15/611; E05Y 2900/544

(57) ABSTRACT

A vehicle tailgate has a closure body configured to rotate between a closed position and an open position at the rear end of a vehicle. A camera is located in the closure body and configured to capture images rearward of the vehicle. A tailgate actuator is configured to actuate the closure body to rotate between the closed position and the open position. A camera actuator is configured to actuate the camera to rotate the camera amongst a plurality of positions. A controller is configured to control the tailgate actuator to rotate the closure body and to control the camera actuator to maintain the camera oriented in the same rearward imaging view throughout the rotational movement of the closure body.

### FIELD OF THE DISCLOSURE

The present disclosure generally relates to vehicle tailgate mounted camera assemblies, and more particularly relates to a vehicle tailgate having a camera that may be repositioned to capture rearview images.

### BACKGROUND OF THE DISCLOSURE

Motor vehicles are commonly equipped with imaging devices in the form of cameras for capturing images in the environment surrounding the motor vehicle. Pickup trucks commonly employ a tailgate at the rear end that may pivot between an upward closed position and a downward horizontal position. The tailgate is commonly equipped with a rearview camera that may be used as a backup camera to capture images rearward of the motor vehicle, particularly during backup maneuvers. The camera is typically fixed onto the tailgate and moves with the tailgate. It would be desirable to provide for a tailgate that captures images rearward of the motor vehicle regardless of the position of the tailgate.

### SUMMARY OF THE DISCLOSURE

According to a first aspect of the present disclosure, a vehicle tailgate has a closure body configured to rotate between a closed position and an open position at a rear end of a vehicle. A camera is located in the closure body and configured to capture images rearward of the vehicle. A tailgate actuator is configured to actuate the closure body to rotate between the closed position and the open position. A camera actuator is configured to actuate the camera to rotate the camera amongst a plurality of positions. A controller is configured to control the tailgate actuator to rotate the closure body and to control the camera actuator to maintain the camera oriented in the same rearward imaging view throughout the rotational movement of the closure body.

Embodiments of the first aspect of the present disclosure can include any one or a combination of the following features:
the tailgate actuator comprises a first motor and the camera actuator comprises a second motor;
the controller generates a common control signal to the first and second motors to control both the rotation of the closure body and the rotation of the camera in sync with each other;
the common control signal comprises a pulse width modulated control signal;
the controller inputs the pulse width modulated control signal to the first motor and the controller inputs the pulse width modulation control signal to the second motor;
the pulse width modulation control signal for the tailgate motor is the same as the pulse width modulation control signal for the camera motor;
the controller monitors a first position of the tailgate and a second position of the camera and further controls the rotation of the camera based on the first and second positions;
a first hall effect sensor senses the first position and a second hall effect sensor senses the second position;
the closure body comprises a tailgate closure body for a pickup truck; and
a pair of pivot hinges allows the closure body to rotate between the open and closed positions.

According to a second aspect of the present disclosure, a pickup tailgate includes a closure body configured to rotate between a closed position and an open position at the rear end of a vehicle. A camera is located in the closure body and configured to capture images rearward of the vehicle. A tailgate actuator having a tailgate motor configured to actuate the closure body between the closed position and the open position. A camera actuator comprises a camera motor configured to rotate the camera amongst a plurality of positions. A controller is configured to monitor a first position of the closure body and a second position of the camera and to control the tailgate actuator to control rotation of the closure body and to control rotation of the camera actuator to control the camera. The controller generates a common control signal to control the tailgate motor to rotate the tailgate and to control the camera motor to rotate the camera in sync with the rotation of the closure body.

Embodiments of the second aspect of the present disclosure can include any one or a combination of the following features:
the common control signal comprises a pulse width modulated control signal;
the controller inputs the pulse width modulated control signal to the tailgate motor and the camera motor;
the pulse width modulation control signal for the tailgate motor is the same as the pulse width modulation control signal to the camera motor; and
a pair of pivot hinges allows the tailgate to rotate between the open and closed positions.

According to a third aspect of the present disclosure, a vehicle has a vehicle body defining a pickup bed having a rear end and a vehicle tailgate coupled to the rear end. The pickup bed end and vehicle tailgate has a closure body configured to rotate between a closed position and an open position at the rear end of a vehicle. A camera is located in the closure body and configured to capture images rearward of the vehicle. A tailgate actuator is configured to rotate the closure body between the closed position and the open position. A camera actuator is configured to rotate the camera amongst a plurality of positions. A controller is configured to control the tailgate actuator to rotate the closure body and to control the camera actuator to maintain the camera oriented in the same rearward imaging view throughout the rotational movement of the closure body.

Embodiments of the third aspect of the present disclosure can include any one or a combination of the following features:
the tailgate actuator assembly comprises a first motor and the camera actuator assembly comprises a second motor;
the controller generates a common control signal to control both the movement of the tailgate and the rotation of the camera in sync with each other;
the common control signal comprises a pulse width modulated control signal;
the controller generates a pulse width modulated control signal from the first motor and the controller generates a pulse width modulation control signal to actuate the motor of the camera; and
the pulse width modulation control signal for the tailgate motor is the same as the pulse width modulation control signal for the camera motor.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper rear perspective view of a motor vehicle configured as a pickup truck having a power tailgate and a synchronized rotating camera module, according to one embodiment;

FIG. 2 is a side view of the power tailgate shown in the closed position with the rotating camera module in a first position;

FIG. 3A is an enlarged side view of the rotating camera module in the position as shown in FIG. 2;

FIG. 3B is a perspective view of the rotating camera module in the first position shown in FIG. 2;

FIG. 4 is a side view of the powered tailgate in the open position with the rotating camera module in a second position;

FIG. 5A is an enlarged view of the rotating camera module in the second position as shown in FIG. 4;

FIG. 5B is a perspective view of the rotating camera module with the camera in the second position; and

FIG. 6 is a schematic diagram of the controls for controlling the power tailgate and the rotating camera module with a synchronized movement.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

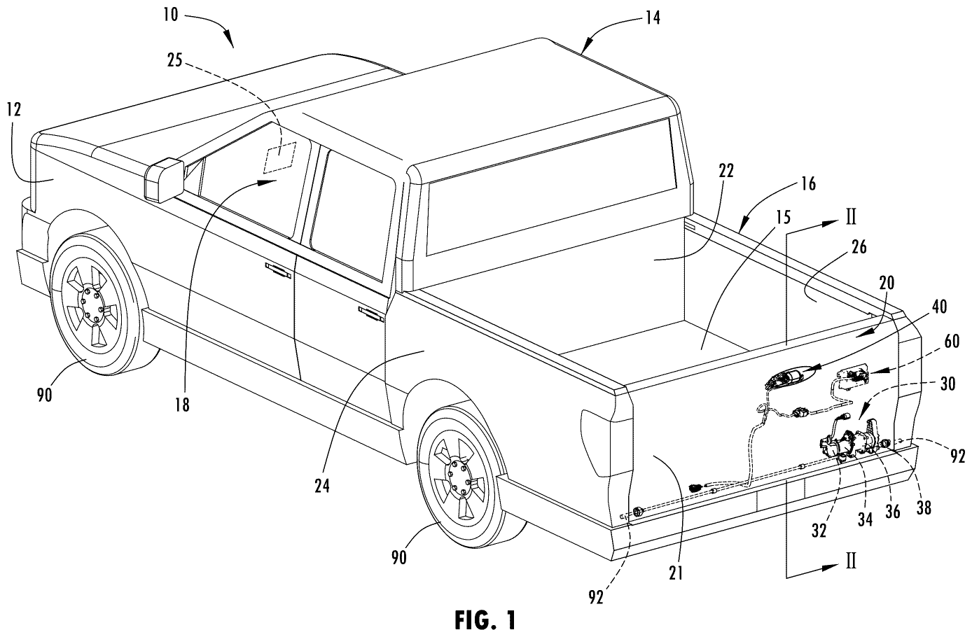

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle tailgate having an actuatable rearview camera. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-6, a vehicle tailgate 20 and a motor vehicle 10 in the form of a pickup truck equipped with the vehicle tailgate 20 is generally illustrated. The vehicle tailgate 20 includes a closure body 21 configured to rotate between a closed position and an open position at the rear end of the motor vehicle 10. The tailgate 20 also includes a camera 42 located on the closure body 21 and configured to capture images rearward of the motor vehicle 10. The vehicle tailgate 20 has a tailgate actuator 32 configured to actuate the closure body 21 between the closed position and the open position. The vehicle tailgate 20 also has a camera actuator 40 configured to orient the camera 42 amongst a plurality of positions. The vehicle tailgate 20 further includes a controller 60 configured to control a position of the tailgate body 21 and to control the tailgate actuator 32 to rotate the closure body and the camera actuator to maintain the camera 42 oriented in the same rearward imaging view throughout the rotational movement of the closure body 21.

The motor vehicle 10 is generally shown in FIG. 1 as a wheeled automotive vehicle configured as a pickup truck that has a vehicle body 12 generally configured with a passenger cab 14 approximately located in the middle portion of the motor vehicle 10 and a bed 16 at the rear end portion of the motor vehicle 10. The motor vehicle 10 has a plurality of tire and wheel assemblies 90. The passenger cab 14 generally defines a cabin interior 18 that typically includes a configuration of vehicle seating assemblies for holding vehicle occupants. The vehicle bed 16 at the rear end portion of the motor vehicle 10 has a bed floor 15, opposing left and right bed sidewalls 24 and 26, and a front wall 22 proximate to the front end of the bed 16 which is proximate a rear end of the passenger cab 14. The vehicle bed 16 further has a rear bed wall provided by the tailgate 20 when in the upright closed position.

The motor vehicle 10 includes the tailgate 20 having the closure body 21 pivotally connected to the vehicle body 12 via a pair of box side pillar hinges 92 that may be supported by a support structure such as the rear support pillars at the rear end corners of the motor vehicle 10. The tailgate 20 is a power actuated tailgate, also referred to as a power tailgate, that includes a tailgate drive unit 30 for actuating the closure body 21 of the tailgate 20 between the upstanding vertical closed position and a horizontal open position. The tailgate drive unit 30 may include a tailgate actuator 32 in the form of an electric motor for actuating the tailgate 20 to rotate between the open and closed position in response to a user input commanding movement of the tailgate 20. The tailgate drive unit 30 may maintain the closure body 21 of the tailgate 20 in a fixed upward or downward position or any position in between, and the tailgate 20 may include an additional latch or latches to hold the tailgate 20 in a latched position.

The tailgate drive unit 30 is shown in one example in FIG. 1 having an electric motor as the tailgate actuator 32 operatively coupled to a clutch unit 34, a gearbox 36 and an output drive shaft 38 that is operative to rotate the closure body 21 of the tailgate 20 to rotate about the hinges 92. The tailgate actuator 32 configured as the electric motor is controlled by a controller 60 in response to an input control signal to actuate the output drive shaft 38 to rotate the tailgate 20 between the open and closed positions by pivoting the tailgate 20 about the box side pillar hinges 92.

The tailgate 20 also includes a rotating camera module 40 which is shown generally located within an upper portion of the tailgate 20 substantially centered between the left and right sides of the tailgate 20, according to one example. The rotating camera module 40 may be located elsewhere on the tailgate 20 sufficient to capture images rearward of the motor vehicle 10. The rotating camera module 40 has a camera 42 that may be used as a rearward viewing backup camera to generate images rearward of the motor vehicle 10 and may be oriented downward at an angle such as 20 degrees, for example, towards the underlining roadway rearward of the motor vehicle 10. The rotating camera module 40 advantageously is controlled to rotate the camera 42 amongst a plurality of different angles in synchronization with the rotation of the tailgate 20 so that the camera-generated images captured within a field of view capture the same field of view irrespective of the rotational position of the tailgate 20 and its rotational position.

The tailgate 20 shown and described herein is a powered tailgate that is powered between the open and closed positions using the electric motor 32 in the tailgate drive unit 30. The tailgate drive unit 30 is controlled by a controller 60 which may be a rear tailgate trunk module, for example. The controller 60 generates a pulse width modulation (PWM) control signal in response to an input request. The control signal is input to the tailgate drive unit 30 to actuate the tailgate 20 to rotate between open and closed positions. The controller 60 also controls rotation of the rotating camera module 40 such that the camera 42 is oriented in a direction to move in sync with the movement of the closure body 21 of the tailgate 20. The controller 60 generates the same pulse width modulation control signal that is input to the camera motor 42 in the rotating camera module 40 to control rotation of the camera 42 as the tailgate 20 is powered to move between the open and closed positions.

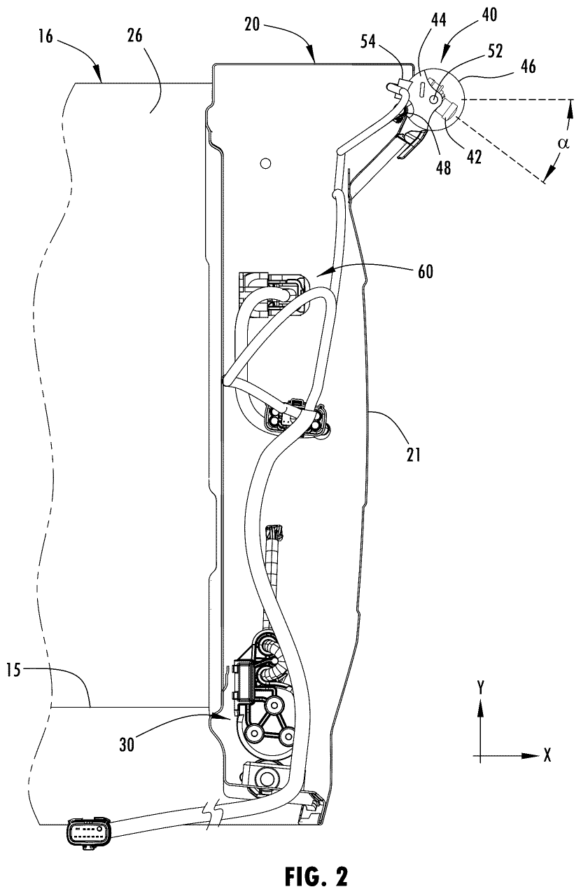

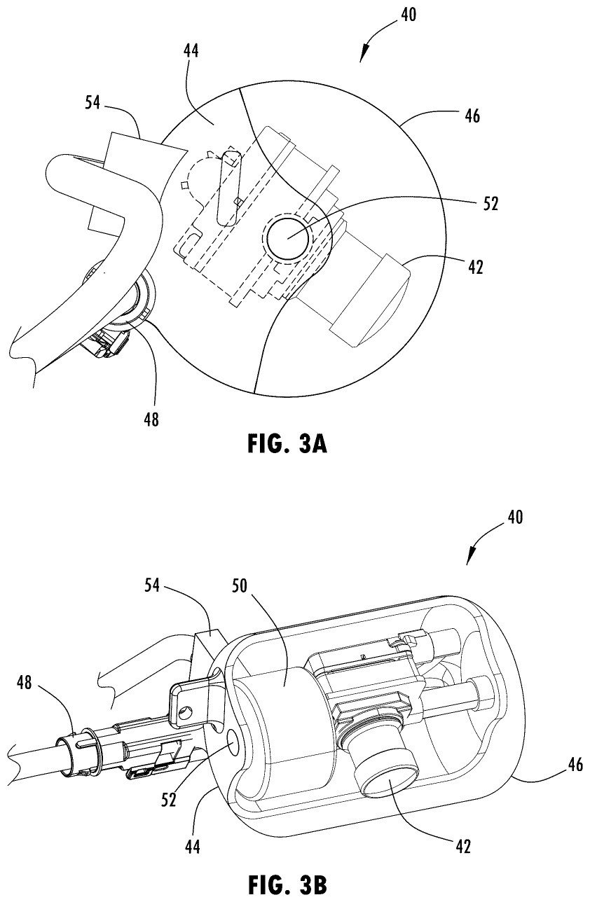

Referring to FIGS. 2, 3A and 3B, the tailgate 20 is shown in the horizontal closed position as seen in FIG. 1. In this position, horizontal access to the truck bed 16 is blocked by the tailgate 20. The rotating camera module 40 is shown in this position having the camera 42 oriented within a field of view directed rearward of the motor vehicle 10 and downward towards the ground at a centered imaging angle a. According to one example, the centered imaging angle a may be in the range of 0 to 45 degrees, for example. By directing the camera 42 at the centered imaging angle a, rearview image within the field of view rearward of the motor vehicle 10 may be captured and presented to the driver of the motor vehicle 10 on a display such as a center mounted touchscreen display 25 and may further be processed for other applications such as trailer assistance, for example.

The rotating camera module 40 is shown in FIGS. 3A and 3B having the camera 42 located within a camera housing 44 and a clear plastic lens 46 which extends from the camera housing 44 to substantially enclose the camera 42 therein. The camera 42 is operatively coupled to a driveshaft 52 which may rotate the camera 42 about the driveshaft 52. The driveshaft 52 is actuated with a servo motor 50 which is an electric motor actuator 32 that operates in response to a controller generated pulse width modulated signal. The servo motor 50 may actuate the driveshaft 52 to rotate the driveshaft 52 to thereby rotate the camera 42 with or without additional gears. A servo motor connection 54 is shown for supplying electric power to the servo motor 50 which is controlled by the controller 60. In addition, a video feed connector 48 is connected to the camera 42 to receive the captured video images. It should be appreciated that the clear plastic lens 46 may be a one-way lens that is viewable from the camera 42 to the outside environment and is substantially hidden from view from the outside environment looking in towards the camera 42.

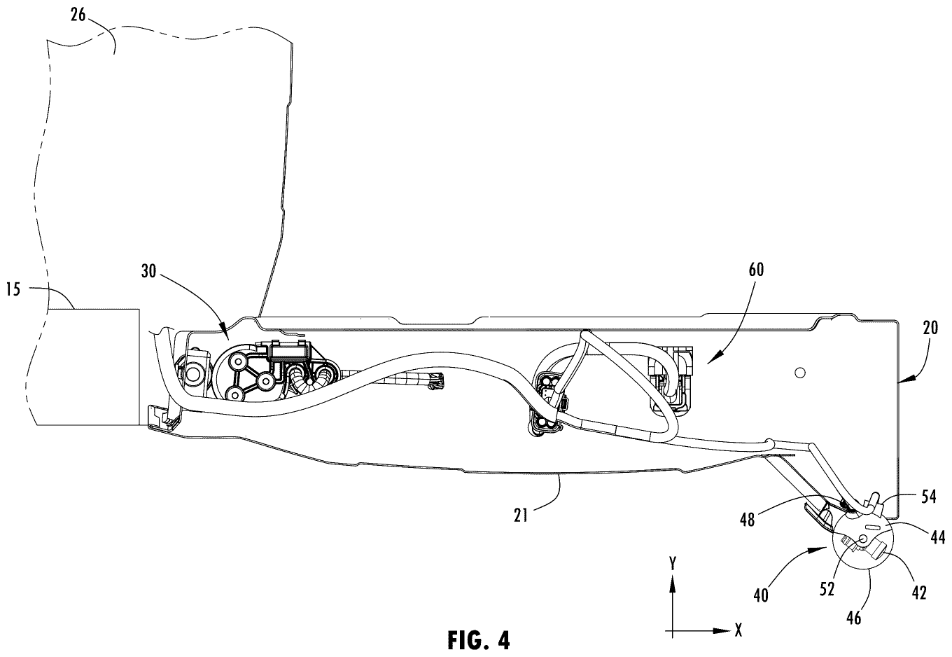

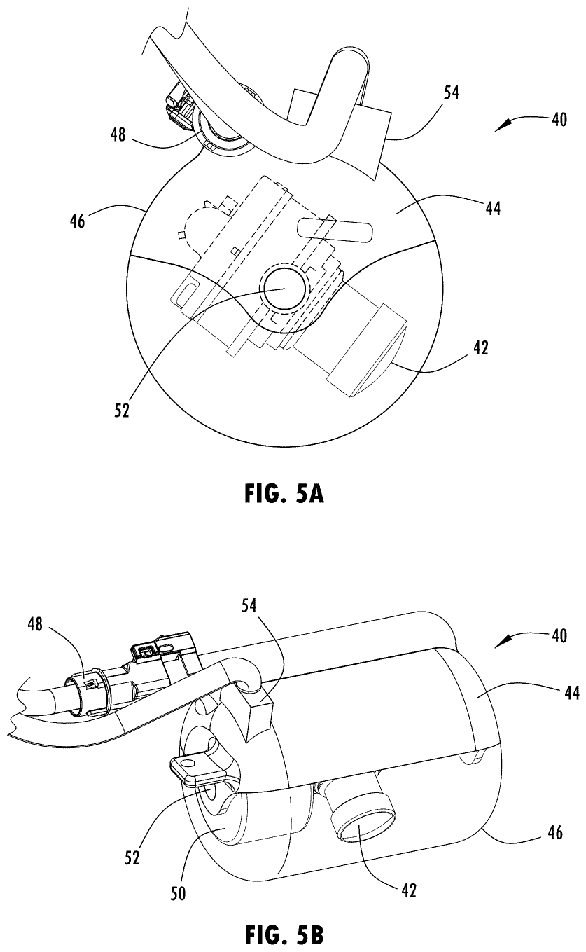

The rotating camera module 40 has the camera 42 oriented in the first position at the centered imaging angled a as shown in FIG. 2 with the tailgate 20 in the closed position. As the tailgate 20 is actuated with the tailgate drive unit 30 to rotate from the closed position to an open position as seen in FIG. 4, the camera 42 is rotated in sync with the angular rotation of the tailgate 20 so that the camera 42 maintains substantially the same field of view for capturing images rearward of the motor vehicle 10 irrespective of the position of the tailgate 20. As seen in FIG. 4, the camera 42 is rotated to a position that maintains the centered imaging angle a at approximately the same angle as in the closed position. This can be seen in FIGS. 5A and 5B in which the camera 42 is rotated counterclockwise relative to the position shown in the closed position.

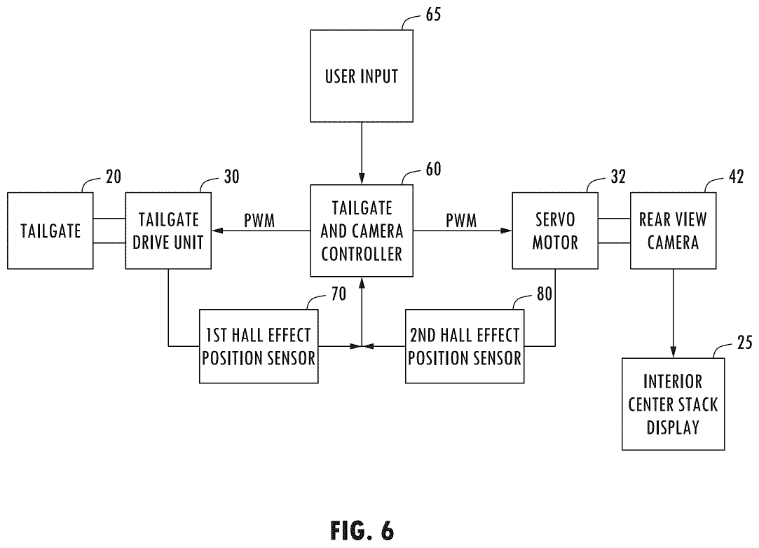

Referring to FIG. 6, the controller 60 is shown controlling both the tailgate drive unit 30 for actuating rotation of the tailgate 20 and the camera actuator 40 for actuating rotation of the camera 42, according to one example. The controller 60 receives an input signal from a user input device 65, such as a user input from a user manipulable switch located on the tailgate outer body, for example, or an input on a keypad, a phone using a phone application, a touchscreen display 25 in the motor vehicle 10, or other available input devices that request that the tailgate 20 move between the open and closed positions. Upon receiving a request to move the tailgate 20 between the open and closed positions, the controller 60 generates a pulse width modulation control signal as an input to the tailgate drive unit 30 to power the tailgate motor to actuate and rotate the tailgate 20 to the user requested angular position. At the same time, the controller 60 supplies the same pulse width modulation control signal to the camera motor 50 that rotates the camera 42 such that the camera 42 maintains the substantially same field of view as the tailgate 20 is rotated amongst a plurality of positions. It should be appreciated that the controller 60 advantageously utilizes the same pulse width modulation control signal to control both the tailgate motor in the tailgate drive unit 30 and the camera motor 50 and allows the tailgate 20 and the camera 42 to move at the same rate and maintain the same direction of imaging view based on the drive unit pulse count end period.

The controller 60 also monitors a first position of the tailgate 20 and a second position of the camera 42 and further controls rotation of the camera 42 amongst a plurality of positions based on the first and second positions. In doing so, a first hall effect sensor 70 senses the rotational position of the tailgate 20. Similarly, a second hall effect sensor 80 senses the rotational position of the camera 42. It should be appreciated that the position sensors 70 and 80 may be attached to the output drive shafts that drive the tailgate 20 and camera 42, respectively, so as to monitor an angular position of both the tailgate 20 and the camera 42. The use of the feedback signals advantageously allows for continuous adjustments to the pulse width modulation control signal and also assures alignment between the tailgate 20 and the camera 42 and correction of any misalignment.

It should be appreciated that the vehicle tailgate 20 as shown and described herein is configured for use on a pickup truck. However, it should be appreciated that the vehicle tailgate 20 may include other vehicle closure body configurations, such as a liftgate that pivots about an upper end, according to another example.

The vehicle tailgate 20 advantageously provides for a powered tailgate that moves between open and closed positions and provides a rearview camera 42 that maintains the substantially same field of view regardless of the position of the tailgate 20. This is achieved by employing the same pulse width modulation control signal, thereby simplifying the synchronization of the movement of the tailgate 20 and the camera 42 in an effective and efficient manner.

It is to be understood that variations and modifications can be made on the aforementioned structure without departing from the concepts of the present disclosure, and further it is to be understood that such concepts are intended to be covered by the following claims unless these claims by their language expressly state otherwise.

1. A vehicle tailgate comprising:
a closure body configured to rotate between a closed position and an open position at a rear end of a vehicle;
a camera located in the closure body and configured to capture images rearward of the vehicle;
a tailgate actuator comprising a first motor and configured to actuate the closure body to rotate between the closed position and the open position;
a camera actuator comprising a second motor and configured to actuate the camera to rotate the camera amongst a plurality of positions; and
a controller configured to control the tailgate actuator to rotate the closure body and to control the camera actuator to maintain the camera oriented in the same rearward imaging view throughout the rotational movement of the closure body, wherein the controller generates a common control signal to the first and second motors to control both the rotation of the closure body and the rotation of the camera to rotate in sync with each other, such that the camera maintains substantially a same field of view irrespective of a position of the tailgate.

2.-3. (canceled)

4. The vehicle tailgate of claim 1, wherein the common control signal comprises a pulse width modulated control signal.

5. The vehicle tailgate of claim 4, wherein the controller inputs the pulse width modulated control signal to the first motor and the controller inputs the pulse width modulation control signal to the second motor.

6. The vehicle tailgate of claim 1, wherein the controller monitors a first position of the tailgate and a second position of the camera and further controls the rotation of the camera based on the first and second positions.

7. The vehicle tailgate of claim 6, further comprising a first hall effect sensor for sensing the first position and a second hall effect sensor for sensing the second position.

8. The vehicle tailgate of claim 1, wherein the closure body comprises a tailgate closure body for a pickup truck.

9. The vehicle tailgate of claim 8, further comprising a pair of pivot hinges that allow the closure body to rotate between the open and closed positions.

10. A pickup tailgate comprising:
a closure body configured to rotate between a closed position and an open position at the rear end of a vehicle;
a camera located in the closure body and configured to capture images rearward of the vehicle;
a tailgate actuator comprising a first motor and comprising a tailgate motor configured to actuate the closure body between the closed position and the open position;
a camera actuator comprising a second motor and comprising a camera motor configured to rotate the camera amongst a plurality of positions; and
a controller configured to monitor a first position of the closure body and a second position of the camera and to control the tailgate actuator to control rotation of the closure body and to control the camera actuator to control rotation of the camera, wherein the controller generates a common control signal to the first and second motors to control the tailgate motor to rotate the tailgate and to control the camera motor to rotate the camera in sync with the rotation of the closure body, such that the camera maintains substantially a same field of view irrespective of a position of the tailgate.

11. The pickup tailgate of claim 10, wherein the common control signal comprises a pulse width modulated control signal.

12. The pickup tailgate of claim 11, wherein the controller inputs the pulse width modulated control signal to the tailgate motor and to the camera motor.

13. The pickup tailgate of claim 12, wherein the pulse width modulation control signal for the tailgate motor is the same as the pulse width modulation control signal to the camera motor.

14. The pickup tailgate of claim 10, further comprising a pair of pivot hinges that allow the tailgate to rotate between the open and closed positions.

15. A vehicle comprising:
a vehicle body defining a pickup bed having a rear end; and
a vehicle tailgate coupled to the rear end and comprising:
a closure body configured to rotate between a closed position and an open position at the rear end of a vehicle;
a camera located in the closure body and configured to capture images rearward of the vehicle;
a tailgate actuator comprising a first motor and configured to rotate the closure body between the closed position and the open position;
a camera actuator comprising a second motor and configured to rotate the camera amongst a plurality of positions; and
a controller configured to control the tailgate actuator to rotate the closure body and to control the camera actuator to maintain the camera oriented in the same rearward imaging view throughout the rotational movement of the closure body, wherein the controller generates a common control signal to the first and second motors to control both the rotation of the closure body and the rotation of the camera to rotate in sync with each other, such that the camera maintains substantially a same field of view irrespective of a position of the tailgate.

16.-17. (canceled)

18. The vehicle of claim 15, wherein the common control signal comprises a pulse width modulated control signal.

19. The vehicle of claim 18, wherein the controller generates a pulse width modulated signal from the first motor and the controller generates a pulse width modulation control signal to actuate the motor of the camera.

20. The vehicle of claim 19, wherein the pulse width modulation control signal for the tailgate motor is the same as the pulse width modulation control signal for the camera motor.
